(19) United States
(12) Patent Application Publication
(10) Pub. No.: US 2005/0128426 A1
(43) Pub. Date: Jun. 16, 2005

(54) Goggles with replaceable lens

(75) Inventor: Chih-Cheng Shiue, Rancho Santa Fe, CA (US)

Correspondence Address: BRUCE H. TROXELL, SUITE 1404, 5205 LEESBURG PIKE, FALLS CHURCH, VA, 22041, US

(73) Assignee: QDS Injection Molding LLC

(21) Appl. No.: 10/867,668

(22) Filed: Jun. 16, 2004

(30) Foreign Application Priority Data
Dec. 12, 2003 (TW) 092221848

(51) Int. Cl. G02C 1/00

(52) U.S. Cl. 351/43

(57) ABSTRACT

Goggles with a replaceable lens having a frame, a soft cushion pad, and a supporting frame into which the lens are inserted. The frame is used for securing and protecting the supporting frame, and both sides of which are fixed to a head belt. The cushion pad is connected to the supporting frame, and includes an apron provided to cover a user's face and may include the eyes, the nose and/or the mouth. The lens is removably inserted into the supporting frame.

### FIELD OF THE INVENTION

The present invention relates to goggles, more particularly to goggles or a mask structure having a cushion pad and a supporting frame with a replaceable lens.

### BACKGROUND OF THE INVENTION

Goggles or masks including lenses, a cushion pad, and a hard frame are known. These goggles or masks maybe used as a swimming mask, goggles, a diving mask, sporting and protecting goggles, and will be referred to hereinafter as goggles.

In conventional goggles, for the sake of manufacturing and waterproofing the lenses of the goggles are fixed in a frame or directly provided on a cushion pad, and are not replaceable.

However, conventional goggles have a deficiency because the lenses of the goggles cannot be replaced depending on different users and different circumstances, such as, a user's eyesight (myopia, hyperopia, etc.), and a variety of lighting conditions and water clarity, and even to provide a sunshade above the water after swimming. In the past, to cope with these shortcomings, some manufacturers tried sticking paper on the lenses in an attempt to customize the lenses.

The structures of conventional goggles are generally classified as one of two types. In the first type, the cushion pad and lenses are clamped between a mainframe and a sub-frame, and a head belt is mounted on opposing sides. In the second type, the lenses are directly covered by a cushion pad, and the head belt is mounted on opposing sides of the cushion pad and located near the lenses. In both types of conventional goggles, lenses are designed to be fixed, therefore the conventional goggles would have to be redesigned to have a removable and replaceable lenses.

### SUMMARY OF THE INVENTION

The object of the present invention is to provide goggles including a frame, a cushion pad and at least a lens supporting frame, wherein the lenses are replaceable.

The object of the present invention is to make the lenses removable and replaceable so that lenses can be selected and used to satisfy a variety of conditions.

The supporting frame of the present invention has a receiving groove for mounting the lens and a removable fastener is provided on the supporting frame. The lens may be clamped within a receiving groove by the fastener.

A clearance between the lenses and the supporting groove should be provided with a waterproof washer.

A contact position between the lens and the receiving groove in the present invention may include a coating of a hermetical material, such as glue, to prevent the lens mounted in the receiving groove from leaking.

In another embodiment, the present invention can be further varied so that the goggles include a supporting frame covered by a cushion pad. The lenses and removable fasteners clamping the lenses are mounted on the supporting frame, and a head belt is fixed on both sides of the soft mask. In this embodiment, the frame in the present invention may be omitted, and the object of interchanging the lenses on a stable supporting frame may be achieved.

The present invention initiates a supporting frame structure, on which the replaceable lens can be mounted.

### BRIEF DESCRIPTION OF THE DRAWINGS

FIG. 1 is a perspective exploded view according to the present invention.

FIG. 2 is a perspective view according to the present invention.

FIG. 3 is a schematic cross-sectional view of one side of the goggles according to the present invention.

FIG. 4 is an enlarged cross-sectional view of area A in FIG. 3.

FIG. 5 is a perspective exploded view illustrating another embodiment of the present invention.

### DETAILED DESCRIPTION OF THE PREFERRED EMBODIMENTS

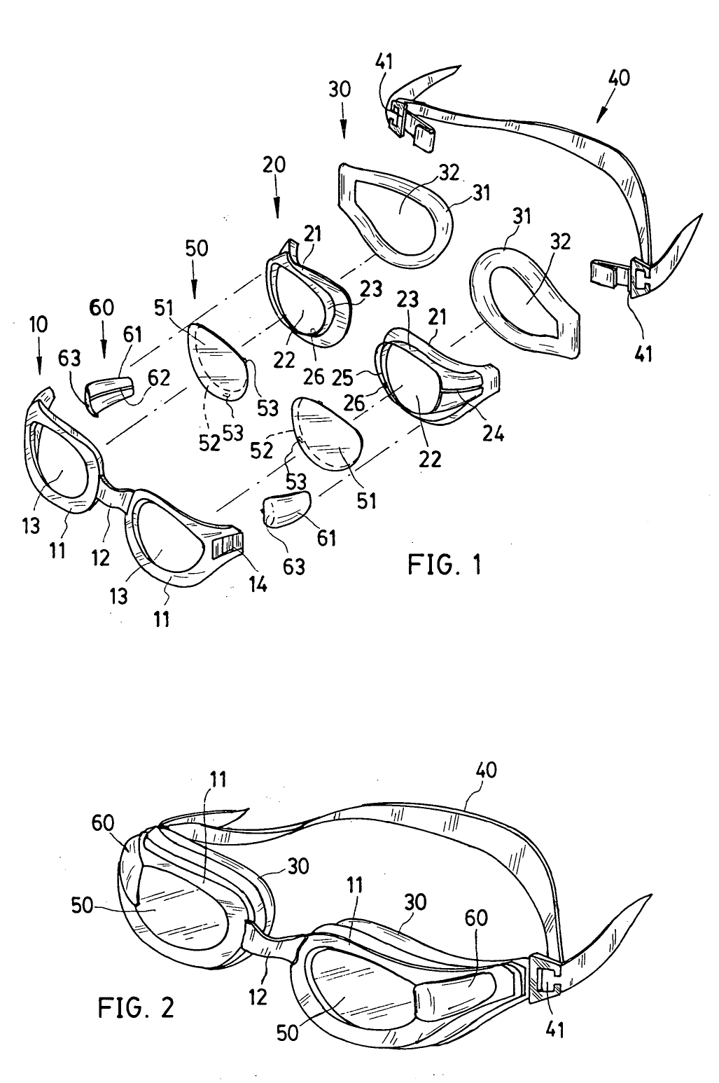

As shown in FIGS. 1 and 2, the invention generally includes a frame 10, supporting frames 20, covering body or cushion pads 30, a head belt 40 and lenses 50. The lenses 50 are connected to the supporting frame 20 by fasteners 60.

The frame 10 has two frame bodies 1 1 and a link 12 provided between the two frame bodies. Each frame body 11 has a lens aperture 13. Opposing sides of the frame 10 have connecting portions 14, which engage with connectors 41 on both ends of the head belt 40, so as to connect the head belt to the frame 10. The connectors 41 allow the tension of the head belt to be adjusted.

It is known to those skilled in the art to use the above-mentioned structure to connect the head belt 40 to the frame 10. The connecting structure and the corresponding adjusting means of the present invention isn't limited to that shown in the drawings.

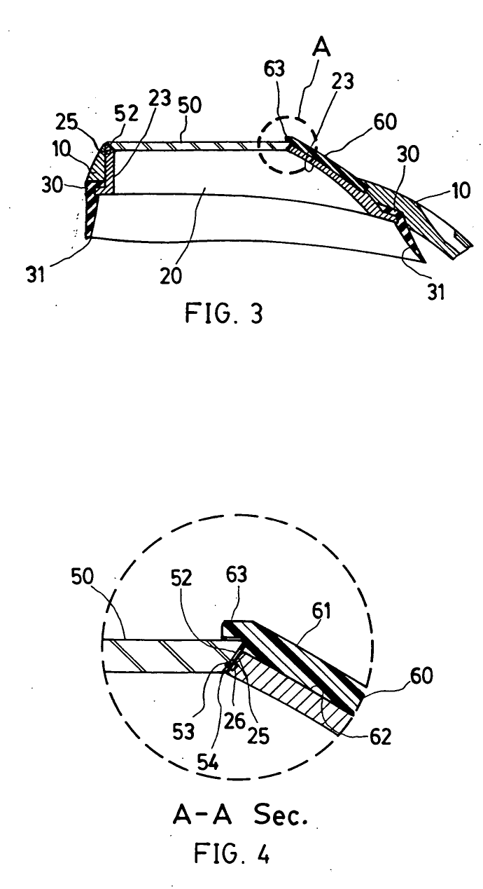

The supporting frames 20 are used to support the lenses 50, which are simultaneously clamped by the fasteners 60 to firmly fix the lenses to the supporting frames 20. Each supporting frame 20, as shown in FIGS. 1-5, comprises a main body 21 having a ring-shaped raised wall 23 surrounding a lens aperture 22 and a groove 24 located on a side of the raised wall 23. An outwardly splayed sloped edge 25 is located on a front edge of an interior periphery of the raised wall 23 and the lens aperture 22, as shown in FIGS. 3 and 4, and includes a plurality of mortises 26. The groove 24 is used to position the fastener 60. The sloped edge 25 and the mortises 26 are provided to connect the lens 50 to the supporting frame 20. The lenses 50 are clamped in the supporting frames 20 by the fasteners 60.

The lens 50 may be customized for numerous conditions including correcting the vision of a user's eyes, optimizing a user's vision for a variety of lighting conditions and water clarity, and providing sunshade above the water.

The cushion pads 30 are used to seal the goggles with a user's face and are generally composed of a soft elastic colloid such as silica gel. In the present invention, the supporting frame 20 may also receive and seal the replaceable lens 50, the structure of which is designed to be waterproof. As shown in FIGS. 1-2, the cushion pad 30 may be two separated parts, one on a left side and one on a right side. However, the two cushion pads 30 may also be an integrated covering structure covering eyes, a nose, and even a mouth. The cushion pads 30 have openings 32 in a center and aprons 31. The apron 31 is provided for close-contacting with face, and the opening 32 is used for positioning and sealing the supporting frame 20. The cushion pad 30 and the supporting frame 20 are held in place by the frame 10 (referencing to FIG. 3).

The lenses 50 allow a user to see outwardly and each includes a lens body 51 having a peripheral edge 52 that is sloped or angled and a tenon 53 corresponding to the mortise 26. The slope of the peripheral edge 52 corresponds with the sloped edge 25 of the supporting frame 20. A sealing layer 54 is applied on or near the peripheral edge 52, so that the lens 50 and the supporting frame 20 are connected with a waterproof seal when the peripheral edge 52 of the lens 50 is positioned adjacent to the sloped edge 25 of the supporting frame 20. Once the lens 50 is engaged with the supporting frame 20, a pressure produced from outside to inside (i.e., in direction of user's eyes) on the lens 50 allows the lens 50 to be connected with the supporting frame 20. Once the fastener 60 is removed, to remove the lens 50, a pressure can be applied from inside to outside against the lens 50 in the lens aperture 22 of the supporting frame 20 so that the lens 50 may be removed and replaced by another appropriate lens.

The fastener 60 may be inserted into and removed from a side surface of the raised wall 23 of the supporting frame 20 to secure the lens 50. The fastener 60 generally includes a body 61 having a projection 62, and a retaining plate 63 provided on an end of the body 61. When the projection 62 is inserted into the groove 24 of the supporting frame 20, the retaining plate 63 secures the lens 50 in the supporting frame 20.

FIGS. 3 and 4 are a partial cross-sectional view and a partial enlarged view of an embodiment of the present invention, wherein a connection between the supporting frame 20 and the cushion pad 30 is protected by the frame 10. Further, a part of the fastener 60 may also be protected by the frame 10.

As shown in FIG. 4, a sealing layer 54 is provided between the slope of the periphery 52 of the lens 50 and the sloped edge 25 of the supporting frame 20. The sealing layer 54 may be a colloid layer formed on the peripheral edge 52, a washer, or a colloid layer formed on the sloped edge 25 of the supporting frame 20 used for sealing and buffering.

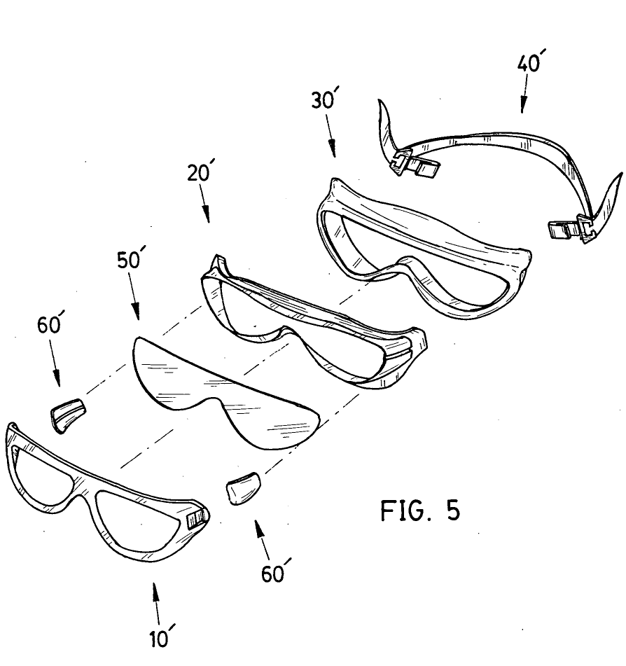

FIG. 5 illustrates another embodiment of the present invention, wherein a frame 10′, a supporting frame 20′, a cushion pad 30′, and a lens 50′ are each integrally formed as one piece. Fasteners 60′ are located on both sides of the supporting frame 20′ respectively. A head belt 40′ is a commonly known component. The lens 50 may also be removed and replaced when the fastener 60′ is removed from the above-mentioned structure, so as to provide a removable lens 50′.

Furthermore, the cushion pad of the present invention may be sealingly connected to the supporting frame with the lens and the corresponding removable fastener and the head belt may be located on both sides of the cushion pad to cover the supporting frame. This structure provides a replaceable lens without a frame body.

In summary, the present invention provides goggles with a replaceable lens, wherein a replaceable lens 50 is connected to and removed from the supporting frame 20 located between the frame 10 and the soft cushion pad 30. Further, a slope structure is also provided between the lens 50 and the supporting frame 20 to enable the lens 50 to be secured in place and to withstand an external pressure. The lens 50 may be sealed with the supporting frame 20 by the sealing layer 54.

The disclosed embodiments of the present invention are only the preferred embodiments. Any minor changes or modifications partially or wholly to the present invention conducted by other professional and made publicly known or familiar shall be deemed to be derived from the present inventive concept and will be within the scope of the claims of the present invention.

1. Goggles with an adjustable head belt comprising:
a) at least one support frame;
b) at least one lens removably connected to the at least one support frame;
c) at least one fastener connected to the support frame and removably securing the lens therein; and
d) at least one cushion pad connected to the at least one support frame.

2. The goggles according to claim 1, wherein each support frame includes a main body having a lens aperture, wherein the lens is removably inserted into the lens aperture.

3. The goggles according to claim 2, wherein each support frame further comprises a ring-shaped raised wall surrounding the lens aperture.

4. The goggles according to claim 2, wherein each lens includes a sloped peripheral edge, and wherein the lens aperture of each of the at least one support frame includes a sloped edge corresponding to the sloped peripheral edge of the lens.

5. The goggles according to claim 1, further comprising a sealing layer between the sloped peripheral edge and the sloped edge of the lens aperture creating a waterproof connection between the lens and the support frame.

6. The goggles according to claim 5, wherein the sealing layer is one of a colloid layer and a washer.

7. The goggles according to claim 1, wherein each support frame includes a groove located on an exterior thereof, and wherein each fastener includes a projection inserted into the groove.

8. The goggles according to claim 1, further comprising a retaining plate located on an end of each fastener adjacent to the associated lens.

9. The goggles according to claim 1, further comprising a frame connected to each support frame.

10. The goggles according to claim 9, wherein each support frame includes a main body having a lens aperture wherein the lens is removably inserted into the lens aperture.

11. The goggles according to claim 10, wherein each support frame further comprises a ring-shaped raised wall surrounding the lens aperture.

12. The goggles according to claim 10, wherein each lens includes a sloped peripheral edge and wherein the lens aperture of the support frame includes a sloped edge corresponding to the sloped peripheral edge of the lens.

13. The goggles according to claim 9, further comprising a sealing layer between the sloped peripheral edge and the sloped edge of the lens aperture creating a waterproof connection between the lens and the support frame.

14. The goggles according to claim 13, wherein the sealing layer is one of a colloid layer and a washer.
